(19) United States
(12) Patent Application Publication
(10) Pub. No.: US 2004/0177018 A1
(43) Pub. Date: Sep. 9, 2004

(54) Financial services production support system and method

(76) Inventors: Richard Michael Fenger, Seattle, WA (US); Preston Alan Graham, Aurora, IL (US)

Correspondence Address: Michael D. Bednarek, Shaw Pittman LLP, 1650 Tysons Boulevard, McLean, VA, 22102, US

(21) Appl. No.: 10/733,411

(22) Filed: Dec. 12, 2003

Related U.S. Application Data
(60) Provisional application No. 60/432,667, filed on Dec. 12, 2002.

(51) Int. Cl. G06F 17/60

(52) U.S. Cl. 705/35

(57) ABSTRACT

A system and method for performing reconciliation of financial records in a distributed enterprise. A central server receives and stores a plurality of files respectively representative of financial transactions. Receipt of the files is monitored and the files are swept to predetermined folders or locations, which are accessed by a reconciliation software package. An application, running on the central server and being other than the reconciliation software package, operates on the central server and provides current reconciliation status information to both personnel responsible for performing the reconciliation and end users whose data is being reconciled.

This application claims the benefit of U.S. Provisional Application No. 60/432,667, filed Dec. 12, 2002, and which is incorporated herein by reference.

### BACKGROUND

1. Field of the Invention

The present invention is directed to production facilities, methodologies and processes in the financial services arena., More particularly, the present invention is directed to systems and methods for facilitating reconciliation of accounts in large enterprises such as financial institutions, and specifically, banks.

2. Backgroune of the Invention

Reconciliation is a necessary practice for any entity that requires or desires accurate financial records. In the case of the banking industry, in particular, account reconciliation is not only of critical importance both in terms of keeping a bank's books in order, but also in terms of complying with applicable laws and regulations that might regulate the banking industry.

Account reconciliation naturally becomes increasingly complex as the volume and complexity of transactions increases. Organization-wide reconciliation is particularly challenging for large financial institutions, which must balance accounts including disbursement, depository, sub-ledger, general ledger, Federal Reserve, traditional bank accounts, foreign, wire transfer and other varied accounts. Multi-site operations compound the problem. Transactions are often spread across multiple accounting systems and various bank accounts. In an enterprise-wide environment, accounts must be accumulated, reconciled and reported from a broad range of sources to clarify a complete and accurate financial picture. Manual methods of reconciliation are time-consuming, expensive and often inaccurate. Given the volume and complexity of transactions, there remains a need for tools to assist in quick, accurate matching especially when single transactions must be matched with multiple transactions.

As is well-known, the difficulty of reconciling records having discrepancies due to errors can quickly become complex. This complexity, to a large degree, is a function of the number of records having discrepancies, the number of records in one listing having no corresponding records in another listing, and in the nature of errors causing discrepancies. For example, if there are many transactions with similar dollar amounts on similar dates, it is difficult to correlate, visually, a record in one list with a similar record (particularly when a difference due to an error or otherwise exists) in the other list. As a result, conventional tools result in an undesirably high number of exceptions that must be manually addressed.

The amount of time required to visually correlate and match erroneous information can be excessive. Accordingly, computers have been relied upon increasingly to facilitate the reconciliation process. One reconciliation computer software package that is commercially-available is a product sold by Checkfree (Atlanta, Ga.) called RECON-PLUS for Windows (hereinafter “ReconPlus”). ReconPlus provides U.S. banks, international banks and corporate treasury operations with automated check and non-check reconciliation's in high volume, multi-location environments. Some of the services provided by ReconPlus are automated deposit verification, consolidated bank account reconciliation and cash mobilization, immediate and accurate funds availability data and improved cash control. ReconPlus is designed to automatically balance virtually any account including disbursement, depository, subledger, general ledger, Federal Reserve, traditional bank accounts, foreign, and wire transfers.

Considering the volume and complexity of present day transactions, the data consistency necessary for quick, accurate matching is often lacking—especially when single transactions must be matched with multiple transactions.

ReconPlus attempts to automate the reconciliation process from the first step. Data is imported either from an internal source such as a general ledger or point-of-sale system, or externally from a bank, such as the Federal Reserve or another source. After the necessary data is received, ReconPlus' matching engine operates to automatically match as many items as possible, based on specified matching criteria. Unmatched records are then made available to be passed through less rigorous matching criteria and/or to be subjected to manual research.

As publicly-available information about ReconPlus explains, multi-site operations compound the problem of accurate reconciliation. That is, transactions are often spread across multiple accounting systems and various bank accounts. In an enterprise-wide environment, accounts must be accumulated, reconciled and reported from a broad range of sources to clarify a complete financial picture. While ReconPlus, to a large degree, can be to tailored to meet specific operating requirements, there are limitations to this commercially-available product in the context of increasingly large and distributed enterprises. Among other things, ReconPlus is not easily scalable to accommodate the needs of large banks.

Thus, despite the advanced functionality of reconciliation software programs such as ReconPlus, such products nevertheless fail to address many of the issues that may be encountered in an implementation of such a product in the context of a relatively large enterprise.

### SUMMARY OF THE INVENTION

The present invention is directed to a collection of tools, components, or applications (many of which can operate independently of each other, or in combination with each other and/or other applications) that improve the overall management and support for a reconciliation software product, such as ReconPlus. It should be understood that the several aspects of the present invention, while having particular relevance to ReconPlus and being explained in the context of this particular reconciliation software package, may also provide the same or other advantages to other similar reconciliation (or even non-reconciliation) software packages that are intended to operate within a relatively large enterprise environment. At a high level, the several (substantially interrelated) functionalities of the present invention manage data files and reports, monitor the current status of relevant databases and file transfers, and provide the current status of each of several databases to users via a network, such as a company intranet. A description of the several individual components of the present invention is summarized below.

File Sweeper

The ReconPlus application reads text files to import data. Each scheduled import job can only use one file path and file name. When the ReconPlus application is finished importing data from a file, it changes the extension on the file. Once a file is renamed, it cannot be imported. Dependencies cannot be set between jobs across different databases. This effectively makes it impossible to share files across databases that share the same file name because the renaming of files cannot be managed.

In accordance with the present invention, each file that is to be read/used by ReconPlus is first sent to a central server. A process is run that moves the file from the root folder to one or more locations. When the file is moved, a version number, based on the current date, is added to the name of the file. This prevents previous files from being overwritten, as the file names are always different from one file to another. The file sweeper component also preferably sends warning emails to support staff if problems are detected with any given file.

The file sweeper component allows the present invention to keep a history of all files that are sent to the central server. After a period of time, these files are no longer needed and can take up a lot of storage space. The present invention preferably deletes all files in a folder that are older than a set number of days. The application allows for defining a retention period for each folder.

File Checker

In an actual implementation of the present invention, approximately 460 relatively large files per day are monitored to determine if each has arrived successfully. It is impractical to manually determine whether each file that is expected has been, in fact, received. The File Checker component of the present invention monitors and automatically determines whether all of the expected files have been delivered. For each file, the following information is preferably recorded: the days of the week the file should be sent, the expected time of arrival, and supplier contact information. If a given file is not received by the expected time, support staff preferably receives an email message. With the supplier contact information readily available, the support staff can quickly begin the process of resolving any problems.

Sidekick—Database Status

In an enterprise such as a large financial institution, individual instances of a reconciliation application with data stored in corresponding databases may have their own respective set of scheduled jobs. It is very cumbersome and time consuming, from a user's perspective, to log into each instance of the application and review the schedule to determine if there are any problems. The Sidekick component of the present invention allows for simultaneously checking of the processing status of each database. Using coded logic, the status of each database is preferably represented using color-coding on a graphical user interface (GUI). Glancing at the GUI quickly apprises a user of the status of the several listed databases. In a preferred implementation, a green highlight means that jobs have been completed successfully. A yellow highlight means that jobs are still processing. A red highlight means that at least one job has failed and will not be retried. Displaying information in this fashion allows for support staff to quickly detect and possibly diagnose systemic problems.

Web Site—Current Status

In a typical implementation according to the present invention, there is preferably an enterprise-implemented ReconPlus web site that also includes a status page that gives end users a current status of a database for which they may be responsible. The status page preferably shows if processing for a database is complete, if accounts are enabled, when files have arrived, current automatch statistics, and any special notices. This web page is based on information contained in this invention's database. The data within this designated database is updated every time an update program runs. In an actual implementation, this program runs every five minutes such that the status information is kept as up to date as practicable. In a preferred implementation, each section of the web page can be manually updated from the Sidekick component.

Sidekick—Special Messages

The Sidekick component of the present invention preferably allows support staff to post messages on the web site in various font colors, sizes, and characteristics. These messages are used to give details to users about specific problems. A typical problem might be a missing file or files. By updating this “message board,” which is integrated into an overall enterprise reconciliation system, users can be kept apprised as to whether any particular problems are being encountered when such problems are likely to be resolved.

Sidekick—Web DB & File Status

The Sidekick component preferably allows support staff to override the automated update program for both file times & processing status of each database. In a preferred embodiment, the override is only for that specific day and resets the following day.

Sidekick—Report Sweeper

Reports can be scheduled in ReconPlus to be created at defined points in time. Each scheduled report job can only be saved to a fixed file path and file name. Generating the same report multiple times will cause previous reports to be overwritten by new ones. The Report Sweeper component runs a process that moves the report file generated and saved by a reconciliation program from a central folder to a different location based on the file name of the report that is created. When the file is moved, a version number, based on the current date, is added to the name of the file. This prevents previous files from being overwritten, as the report file names are always different from one file to another. The report sweeper component also preferably sends warning emails to support staff if problems are detected with any given file.

Sidekick—Report Checker

ReconPlus uses Crystal Reports available from Crystal Decisions, Palo Alto, Calif. to create reports. However, it has been determined that in many instances ReconPlus and Crystal Reports do not communicate well. There are times when a report fails to create and ReconPlus does not recognize this. The Sidekick component preferably includes functionality to verify the creation of each report by checking for the physical file that should have been created for a given report. The application preferably stores the location of where each report is stored to determine which reports should be created for each company or entity that is being served by ReconPlus.

These and other features of the present invention and their attendant advantages will be more fully appreciated upon reading the detailed description in conjunction with the accompanying drawings.

### BRIEF DESCRIPTION OF THE DRAWINGS

FIGS. 1A and 1B are schematic diagrams illustrating features of the present invention.

FIG. 2 shows an exemplary database status page in accordance with the present invention.

FIG. 3 depicts a series of exemplary steps for obtaining data to display on the status page of FIG. 2.

FIG. 4 shows a WebResults table in accordance with the present invention.

FIG. 5 depicts a series of exemplary steps for conducting a file sweeping method in accordance with the present invention.

FIG. 6 shows an InputFiles table in accordance with the present invention.

FIG. 7 shows an exemplary web status page in accordance with the present invention.

FIG. 8 shows an exemplary graphical user interface for entering special notices onto the web status page of FIG. 7.

FIG. 9 shows an exemplary series of steps that show how aspects of the present invention function in connection with an overall reconciliation process in a large distributed enterprise.

FIG. 10 shows a DisableLogin table in accordance with the present invention.

FIG. 11 shows a WebFileTimes table in accordance with the present invention.

FIG. 12 shows a CompanyInfo table in accordance with the present invention.

### DETAILED DESCRIPTION OF THE INVENTION

The reconciliation process of any account can be a complex undertaking. Before it is even possible to begin this process, it is necessary to receive all of the electronic files that are to be used in the reconciliation process. In the case of a large financial institution, such as a bank, there may be over 100 different entities (subsidiaries, partners, etc.) from which files must be obtained. And, there may be on the order of 10,000-20,000 individual reconciliation tasks that are designated to be processed on a periodic, typically daily, basis.

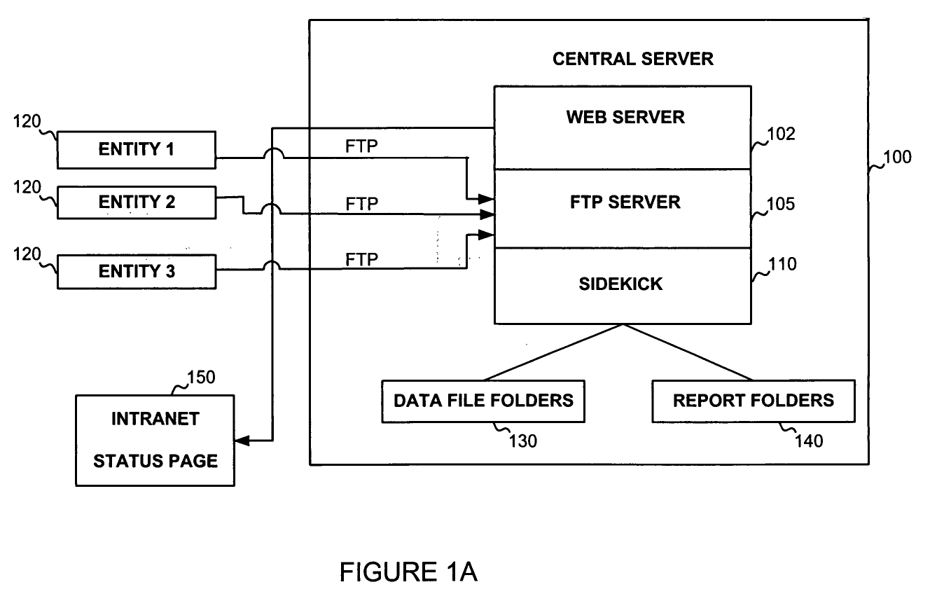

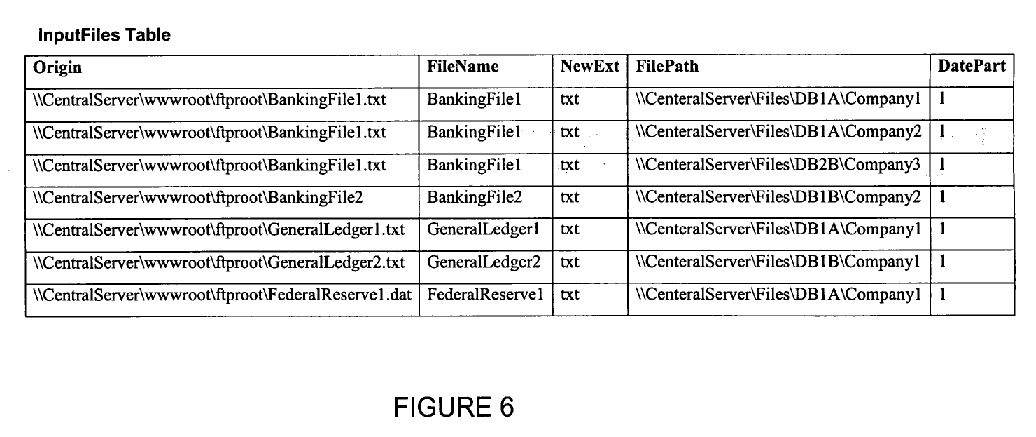

In accordance with the present invention, ReconPlus data (the electronic files that are received from the several entities and the resulting reconciliation files (recs)) is received and then stored in a plurality of folders that are arranged in a central server. In an actual implementation of the present invention, multiple companies (entities) are assigned to each folder. FIG. 1A shows data file folders 130 that reside on central server 100. Also shown, in accordance with the present invention, is a Sidekick component 110 (or simply Sidekick 110), which enables the data handling procedures to be described later herein. Each data file folder stores at least one file received from one or more entities 120. These entities represent individual banks, partner banks, subsidiaries of these institutions, and any other institution that is involved in having to reconcile its accounts with a parent's or controller's accounts. Also shown in FIG. 1A is a Web Server 102, report folders 140, and an intranet status page 150, an example of which is shown in FIG. 7.

While the commercially-available versions of ReconPlus are marketed as allegedly being able to support enterprise-wide reconciliation, the present inventors have identified a critical deficiency in the ability of this software package to handle large numbers of items. Specifically, it has been found that the system's (ReconPlus') performance degrades when the number of records being simultaneously handled in any single database approaches 1 million.

To alleviate the strain on the ReconPlus package, the present invention splits up the incoming data into several data file folders 130, each preferably organized by instances of a reconciliation application and their corresponding databases, like those shown in FIG. 1B, which, in this case, reside on different servers 160. This is a novel implementation of ReconPlus in the sense that the ReconPlus software package is not designed to operate in a multi-instance environment managed from a central server. While not essential, the several databases are preferably mapped to business functions within the enterprise. For example, one database might be associated with Entity 1 and Entity 2, each of which have some commonality of purpose in the “real” business world. However, as indicated, mapping of the business functions to particular databases on particular servers is not a critical aspect of the present invention.

As shown in FIG. 1B, each instance of the reconciliation application reads text files stored on central server 100 that are preferably formatted in an agreed-upon format or structure from the different entities and loads the data into the appropriate database resident on one of the database servers 160. Physically, an FTP service (FTP server 105, FIG. 1A), for example, may be arranged to pass the data from the individual entities 120 to central server 100. Formatting can also be accomplished after receipt of the data at the particular database, if necessary. When files are confirmed to have been received and moved to their appropriate location, (a function of Sidekick 110), ReconPlus accesses the individual files and performs its automated reconciliation process. Typically, reconciliation is performed between the data received from one or more entities and the bank's general ledger for “balance sheet accounts.” However, reconciliation can also be accomplished for off balance sheet accounts, including, for example, employee reimbursement accounts or 401k accounts.

As can be readily appreciated by those skilled in the art, managing all of the files and the processing of multiple instances of a reconciliation application is a difficult task. However, this task is substantially simplified by the features of the present invention. Specifically, the present invention monitors and lists for the user each scheduled task or job that must occur for each instance of a reconciliation application. In a typical implementation, each instance has hundreds of jobs scheduled each day. In the context of the present invention, a “job” can be an “import” operation for a particular file, the actual reconciliation process, or a reporting function.

In conventional implementations of ReconPlus in a large enterprise, there must be two, or even three, people assigned to each database to monitor the scheduled jobs to ensure that all jobs are or have been successfully performed. In an enterprise that implements four databases, for example, there would have to be eight or twelve people assigned to the monitoring task. However, this is obviously inefficient and uneconomical. Moreover, for reasons not clear to the present inventors, the ReconPlus package itself requires several seconds (or more) to indicate, after being requested to do so, the status (success/failure/executing/retry/idle) of a particular scheduled job. It is therefore not surprising that, in conventional implementations, several people are needed to monitor the status of the ReconPlus package.

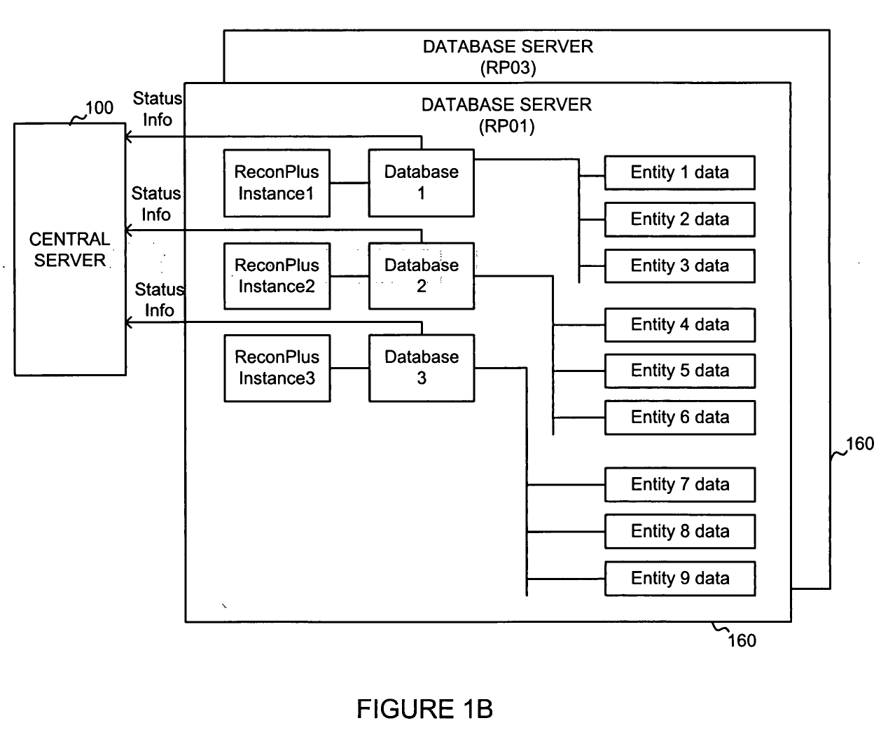

A database Status Checker—Screen Layout, shown in FIG. 2, illustrates an exemplary display of the processing status of each instance of ReconPlus (processing data in accordance with a corresponding database) (e.g., AANAFIN2, AASC, CRISP . . . ), split up by server (e.g., RP01, RP03, RP04), along with a listing of the several jobs (e.g., purge, import, reconcile (Rec) . . . ) scheduled for the selected database.

There are, potentially, many problems that can occur during the execution of the scheduled jobs. Specifically, files may not arrive on time, or the reconciliation process may not complete properly. With so many files and processes running, the overall operation is difficult to manage. With the present invention, however, it is possible to get a “bird's eye view” of all of this information. Specifically, as can be seen in FIG. 2, all of the instances of ReconPlus with their corresponding databases are listed on a single screen, are categorized by server, and, in a preferred embodiment, each is given a highlighted color coding based on its status: red for true fails, yellow for in process, and green for completed successfully. If there are any red indications, then it can be immediately known that one or more of the databases has experienced problems.

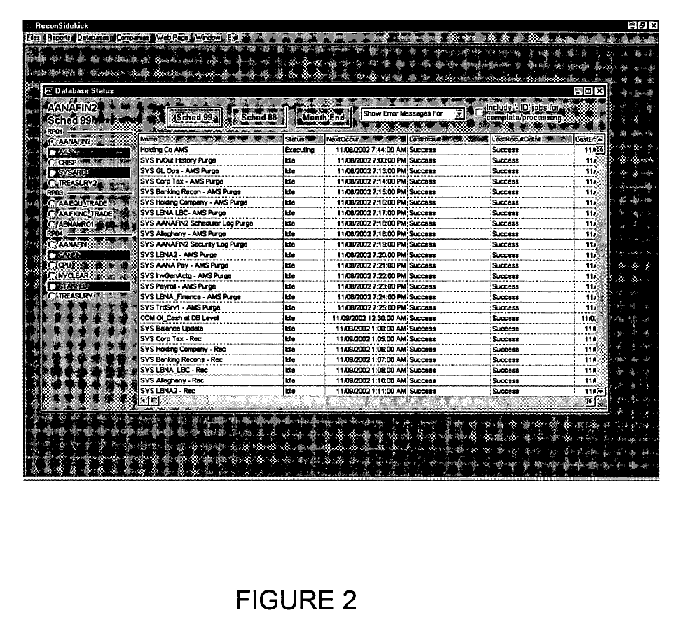

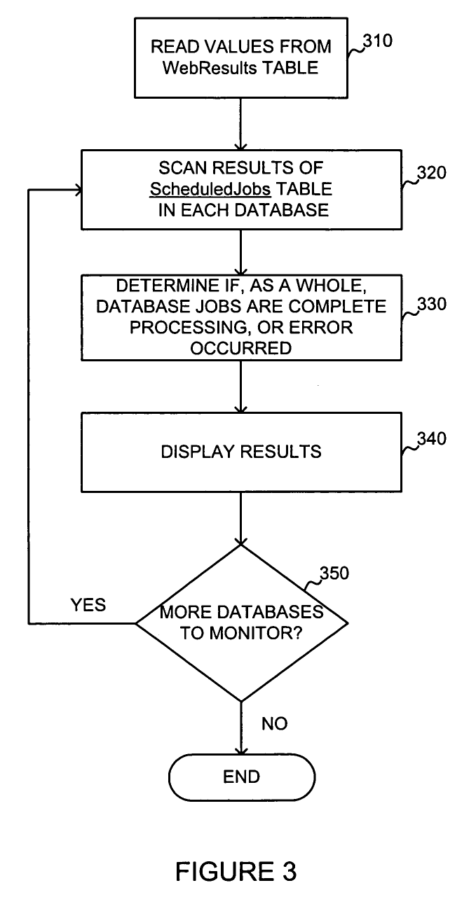

The present invention provides a method by which Sidekick 110 scans the processing status each of the ReconPlus databases and selects only that information that is necessary to provide virtually instantaneous status information. Specifically, with reference to FIG. 3, Sidekick 110 of the present invention, at step 310, reads the values in a Sidekick specific WebResults table (shown in FIG. 4) to determine what databases to query and where the databases exist. Then, at step 320, Sidekick scans the results of the ReconPlus specific ScheduledJob table within the identified databases. This is shown as “status info” being sent from the respective databases to central server 100.

Using a combination of the available “Status,” “NextOccur,” and “LastEnd” fields for each scheduled job as recorded in the ScheduledJobs table, Sidekick 110 determines at step 330 if, as a whole, the jobs for each database are complete, processing, or an error occurred. Sidekick 110 then displays, at step 340, the results on one page with each database listed in a column next to a data grid, as shown in FIG. 2. The status of each database is preferably represented by the background color of the database list. Green means processing is complete. Yellow means the database is still processing. Red means an error occurred. By clicking on a specific database from the list, the data grid displays the detailed status of each scheduled job for the selected database. As can be readily appreciated by those skilled in the art, this process can handle multiple databases on either one server or multiple servers.

Job failures can occur because a file goes into a retry state and continues in that state for a predetermined period of time, or bad data is received, e.g., a bad record that causes ReconPlus to halt processing. Because the present invention accesses only the relevant information from each database on each server, it is possible to quickly provide a complete status picture to a user.

As will be readily appreciated, quick overall system analysis can be achieved with the present invention. For example, it can be quickly determined if files were or were not received, or if a problem with a reconciliation job has occurred. That is, if the status of the many instances of ReconPlus are displayed in red, one can quickly look at the files that were expected, but may indeed be missing. On the other hand, if all the files are received and there is a red indication, then perhaps bad data is the culprit, or some other error caused a failure. In the latter cases, a call could be placed to the service provider (person responsible for the source of the data at the particular entity) to investigate why there might be a problem with their data. Still another possibility is that there could be a true system problem on the ReconPlus side, i.e., a reconciliation processing error.

Thus, this aspect of the present invention quickly and efficiently presents the user or controller with a list of issues that may need to be resolved. More specifically, the present invention provides the ability to achieve the level of service necessary to operate a large financial enterprise. By 8:00 am, for example, after a night of processing, it is possible to confirm that all jobs have been completed successfully, or alternatively, quickly identify problem areas.

It is noted that the tools of the present invention are applicable to almost any system that has the task of managing file transfers from multiple data providers and managing that data for systems spread across multiple servers. The tool also provides for monitoring the processing of this data by the multiple instances of a reconciliation application.

File Sweeper

As explained above, the present invention monitors all scheduled jobs across multiple databases within the ReconPlus environment. Typically, every database is independent, and within each database there is stored data associated with a plurality of entities or companies. To further manage the reconciliation production environment, the present invention also provides a “file sweeper” component. In conventional implementations of ReconPlus, files are typically stored in one folder and are accessed from that folder. In accordance with the present invention, on the other hand, files are taken from a central receiving location and distributed, or “swept,” into a definable folder structure on central server 100 that stores the appropriate entity or company. When moved, the files are also preferably given a unique date stamp, thereby efficiently assigning a version number to each file and precluding subsequent files of the same name, but received on a different date, from overriding one another.

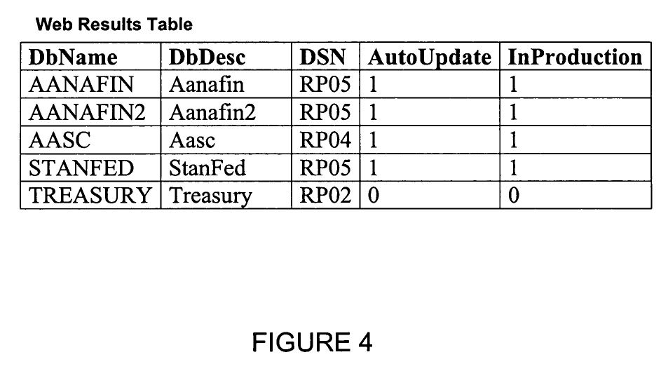

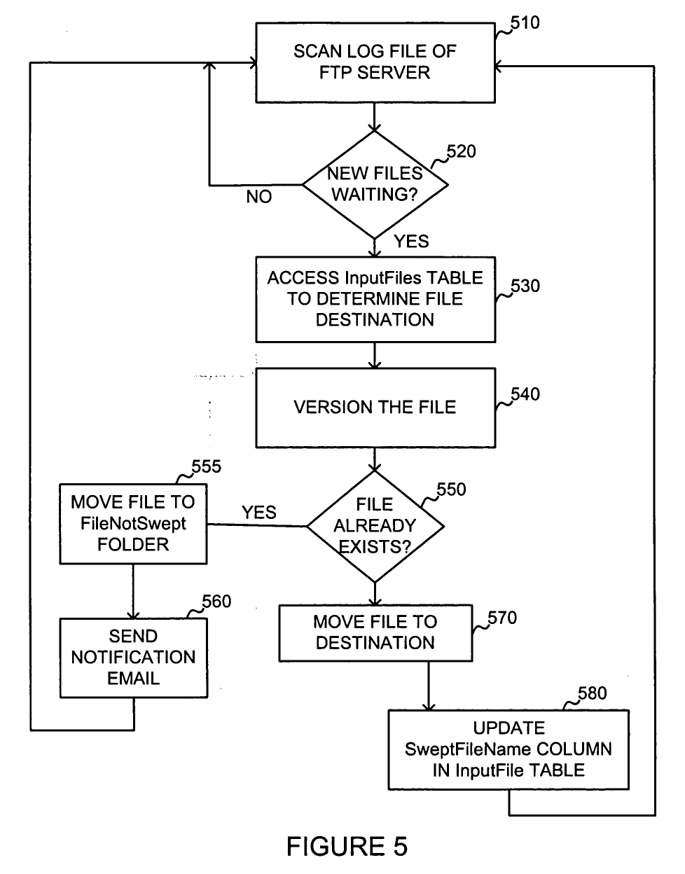

More specifically, and with reference to FIG. 5, the file sweeper process moves files from the root ftp folder to one or more other folders. At step 510, the file sweeper periodically scans the log file of FTP server 105 to determine if any new files have arrived. At step 520, if new files are present, the sweeper component reads from an InputFiles table (shown in FIG. 6), at step 530, to determine where the file should be placed and what name to give the file. Before the file is moved, it is versioned at step 540 by having the current date or date and time appended to the end of the name of the file. It is then determined at step 550 whether that versioned file already exists. If so, the file is moved to a definable location. In an actual implementation of the present invention, this location is a folder called ‘FileNotSwept’, as indicated by step 555, and, at step 560, a notification message, e.g., in the form of an email, is sent to the appropriate support staff to ensure the proper follow-up is conducted. If the file does not already exist, then at step 570, the file is moved, or swept, to the appropriate destination consistent with the InputFiles table. At step 580, the program updates the “SweptFileName” column in the InputFiles table.

The file sweeper component also preferably keeps a history of all files that are sent to the central server. After a period of time, these files are no longer needed and can take up a lot of storage space. The present invention preferably deletes all files in folders that are older than a set number of days. The application preferably allows for defining a retention period for each folder.

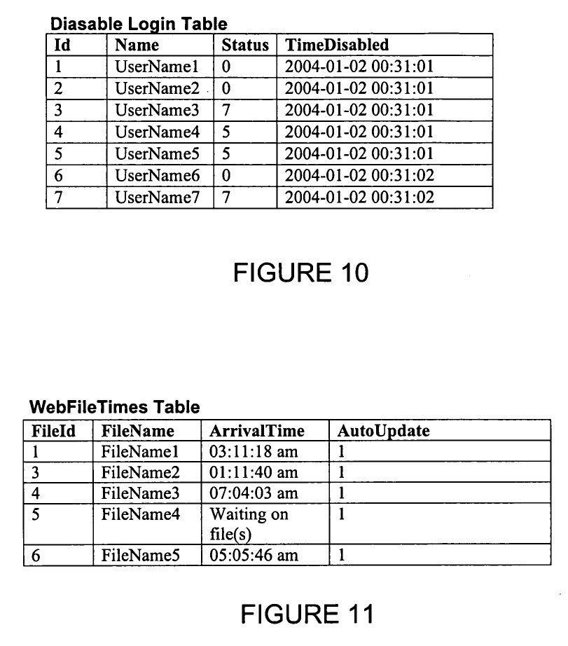

At any time, a file checking routine is preferably run to confirm that each expected file has actually arrived successfully. A File Checker component of the present invention monitors and automatically determines whether all of the expected files have been delivered. For each file, the following information is preferably recorded: the days of the week the file should be sent, the expected time of arrival, and supplier contact information. If a given file is not received by the expected time, support staff preferably receives an email message. A list of non-received files may also be posted for staff to view. With the supplier contact information readily available, the support staff can quickly begin the process of resolving any problems. FIG. 11 shows a Sidekick specific WebFileTimes table that records arrival times of expected files.

Web Status

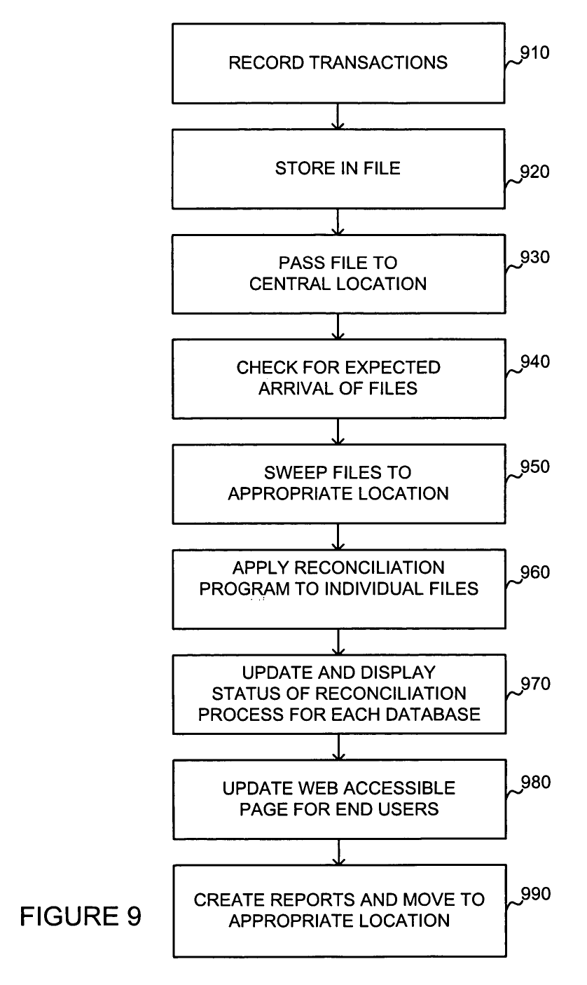

In addition to the back office database and file monitoring tools described above, the present invention also offers a web-based end user support tool. To an end user, namely the individuals responsible at a given entity, the most important information is often whether their particular reconciliation has completed successfully. Conventionally, this information is passed by telephone from person to person—an obviously inefficient method. The present invention, in contrast, repackages much of the information in the database monitoring tool and offers this up in a web-based application, a page of which is shown in FIG. 7. The technical methods and systems for implementing such visual web-based applications are well-known in the art. A unique feature of the present invention, however, is the ability to make this type of information available to end users at all. In a preferred embodiment, information displayed includes whether end users are presently enabled or disabled (a related feature, website lockout is discussed below). FIG. 10 depicts a Sidekick DisableLogin table from which login access is keyed. This information can also be color coded, e.g. green for enabled, red for disabled. Also included is overall status including what time a job finished. This functionality, by itself, is estimated to save the time of one full time employee, by avoiding having to answer repeated telephone calls from end users. Preferably, this utility is updated automatically every five minutes, or other reasonably short time, to promulgate the most up to date information as possible.

The Web Status update provides users with a current status of all jobs processing. In a preferred implementation, the web status component reads values from the WebResults table (FIG. 4) to determine what databases to query and where they exist. Based on the data within the WebResults table, Sidekick 110 scans the values in the ScheduledJob table within the reconciliation application's databases. The Web Status tool then counts the number of records in a ‘DisabledLogin’ (FIG. 10) table in each ReconPlus database. If there are records, then users are disabled. If there are no records, users are enabled.

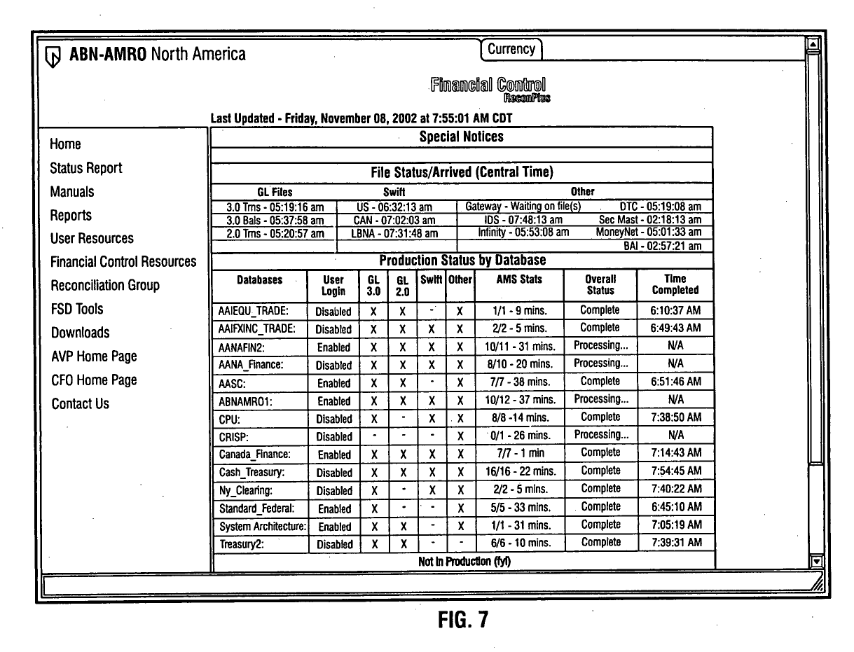

Then, using a combination of the Status, NextOccur, and LastEnd fields for each scheduled job, Sidekick 110 determines if, as a whole, the jobs for the database are complete, still processing, or an error occurred. The WebResults table (FIG. 4) is then updated to reflect this. For each file identified in the WebFileTimes table (shown in FIG. 11), the application scans the InputFiles table to determine if and when the file was sent. If the day of the week flag for the current day is true, the application looks at a DateLastReceived column (not shown). If that date is the current day, the WebFileTimes table is updated with the time. If that date is not the current day, then the WebFileTimes table is updated with ‘Waiting on File(s)’. The Status Page (FIG. 7) on the web site reads the values in the WebResults, WebMessages, and WebFileTimes to create the content shown. Those skilled in the art will appreciate that this process handles multiple instances of an application. Also, in a preferred implementation, the results returned by this tool can be manually overwritten, if necessary. Text messages can also preferably be entered through the Web Status tool and displayed under the “Special Notices” banner in FIG. 7. Text may be entered using a browser-based graphical user interface like that shown in FIG. 8 that permits the user to format the text in a desired fashion.

WebSite Lockout

In a preferred implementation, in order to ensure that processing is successful, it is sometimes necessary to lock out all users from requesting status information. One solution is to run a script that “turn everybody off,” and users are given access only after it can be reasonably assured that all jobs have completed successfully. This feature is helpful to address resource contention, wherein there may be a plurality of users accessing the same database, that happens also to be in the process of importing files and auto matching.

Report Sweeper

Scheduled jobs in ReconPlus create and save reports to a single location. Examples of such reports are point-in-time reconciliations, purged items, and audit trail reports. In accordance with the present invention, a report sweeper component (which preferably runs every hour) parses the file name of the report and moves it to a new location based on the file name. The following is an example:

The file is saved as \\Central\Server\WebRpts\Database1-Company1-ReportType-ReportName.txt

The file is then moved to (with a date stamp)

\\CentralServer\Reports\Database1\Company1\ReportType\ReportNa meyymmdd.txt

Report Checker

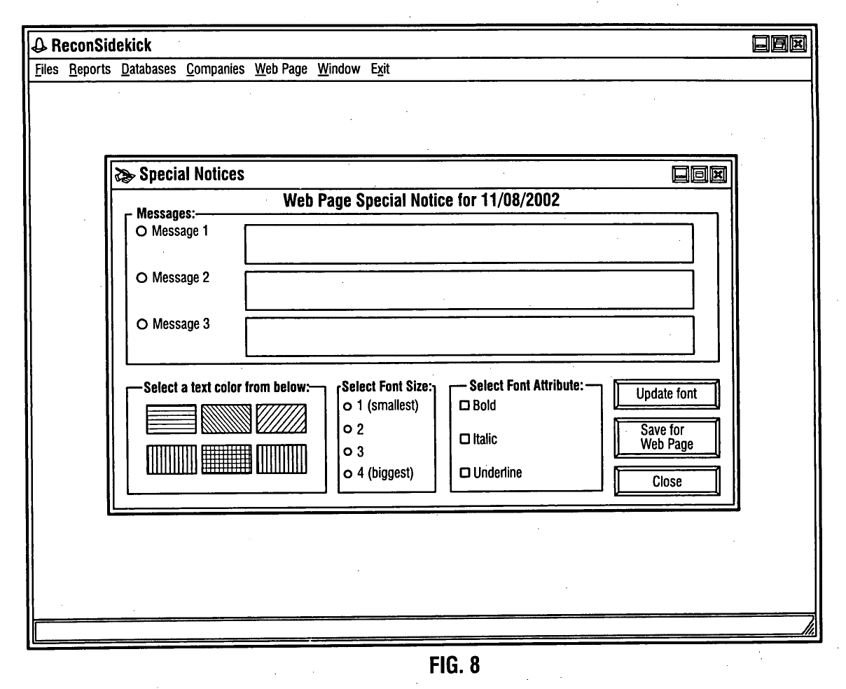

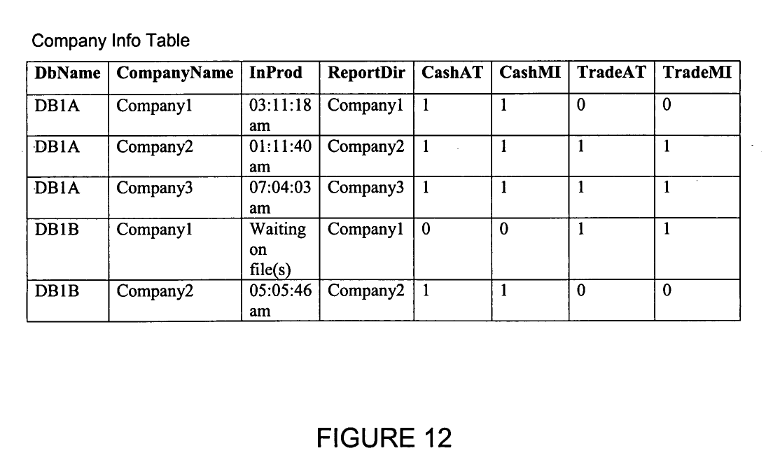

Sidekick 110 preferably includes functionality to verify the creation of each report requested to be run by ReconPlus by checking for a physical file that should have been created for the given report. The application reads values in the Sidekick specific CompanyInfo table (FIG. 12) to determine which reports should have been created for each company or entity that is being served by ReconPlus. Sidekick 110 also reads the values in the CompanyInfo table to determine which reports to validate and where the reports exist. The application checks for physical report files in specific folders and accounts for the version numbers appended to the reports from the Report Sweeper component. Report files are preferably placed in report folders 140 resident on central server 100. In view of all the foregoing, those skilled in the art will appreciate that the present invention provides significant advantages when attempting to employ a reconciliation software package such as ReconPlus in a large enterprise environment. FIG. 9 shows how aspects of the present invention are intertwined with an overall reconciliation process that employs multiple files received from multiple distributed entities. Specifically, at step 910 transactions preformed at the individual entities are recorded electronically. Then, at step 920, the transactions are stored in appropriate files. These files are then passed to a central location at step 930. The central location is preferably a central server. In a preferred embodiment, the files are transferred from the individual entities to the central server via an FTP transfer facility.

Then, at step 940, the files that are expected to arrive on a certain day or by a certain time are checked. If files are missing, the appropriate personnel are notified via, for example, an email message. Step 940 can be performed multiple times throughout the process, and in particular, can be performed before or after subsequent step 950. At step 950, the files that have been received are “versioned” with appropriate file names such that files are not inadvertently copied over. The files are then “swept” into the appropriate location. In a preferred embodiment, folders are arranged such that the files stored therein are related to each other with respect to the entities from which they came.

At step 960, a reconciliation program, such as ReconPlus, is then applied to, or works, on the data resident in the files swept to various locations from step 950. The present invention, by way of Sidekick 110, facilitates the means in which multiple instances of a reconciliation program can access data from an organized central repository. This process continues until the entire reconciliation process is completed with respect to each of the received files for each of the databases.

At step 970 the status of the reconciliation process for each instance of a reconciliation program is monitored and preferably displayed for the reconciliation controller. This information is preferably updated regularly so that the controller has the most current information available. In a preferred embodiment of the present invention, the entire process of sending files to the central server, sweeping them into the appropriate locations, conducting the necessary reconciliation and displaying the status of the reconciliation process is all completed during overnight processing such that when a controller comes to work on any given morning, that controller can quickly and easily determine whether the overnight processing has proceeded smoothly, or whether there are issues to be resolved before the various entities from which the files containing the transaction data have been received can begin their respective operations.

At step 980 the present invention, via a web accessible page, provides status information to end users with respect to the files received from the entities with which the end users are associated. This web accessible page is preferably periodically updated such that the end users also have the most currently available information from which to work.

At step 990, reports are created and saved which capture the current state of the data. These reports are preferably saved to a central location. Finally, the reports are moved to new locations and renamed with the current date appended.

Those skilled in the art will appreciate that the present invention provides significant advantages in that a reconciliation software package such as ReconPlus, designed primarily to operate from a single instance with an underlying database on a single server is now operable to conduct reconciliations on files with multiple instances of a reconciliation program, each with an underlying database, distributed across many servers with multiple instances running from a single server. Moreover, the present invention provides significant savings in manpower since the movement of data from various entities into appropriate databases are automatically monitored to determine if the dataflow is continuing as expected. When anomalies occur, the present invention can quickly identify that an error or anomaly of some kind has occurred and immediately indicate a status change in this regard.

As will be appreciated by those skilled in the art, the present invention has wide applicability to managing virtually any complex production situation. The applications, tools and components of the present invention are designed such that they can impart both scalability and manageability. To scale the system, for example, tables and rows can be added to the present invention, thereby providing the ability to add more and different types of databases. As a result, it is possible to centrally manage more file exchanges and more uses of the files.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for performing reconciliation of financial records, comprising:
a server including a file transfer service that is operable to receive a plurality of files from a plurality of distributed entities, the plurality of files respectively storing data representative of financial transactions respectively recorded by the plurality of distributed entities;
a reconciliation software package configured to operate on at least a subset of the plurality of files; and
an application, other than the reconciliation software package, operating on the server, that allows the reconciliation software package to access the data in the plurality of files in order to perform reconciliation.

2. The system of claim 1, wherein the file transfer service is consistent with the File Transfer protocol (FTP).

3. The system of claim 1, wherein the plurality of files are stored in folder groups by database in accordance with predetermined business relationship among the entities.

4. The system of claim 1, further comprising means for monitoring files received from the distributed entities and indicating whether at least one of the plurality of files has not been timely received.

5. The system of claim 1, further comprising means for sweeping files received at the server to other locations.

6. The system of claim 5, wherein the means for sweeping comprises means for versioning the files received.

7. The system of claim 1, further comprising means for determining and displaying the status of tasks being performed by each of the databases.

8. The system of claim 1, further comprising means for providing status information to end users from whom the plurality of files are initially received.

9. A method of performing financial records reconciliation, comprising:
recording a plurality of financial transactions;
storing data representative of a first portion of the financial transactions in a first file and data representative of a second portion of the financial transaction in a second file;
sending the first and second files to a central server;
ascertaining whether the first and second files are timely received, and if not, initiating a notification procedure;
sweeping the first and second files to predetermined locations on the central server;
performing financial reconciliation on the data in the first and second files; and
displaying status information with respect to the state of files receipt and the step of performing financial reconciliation.

10. The method of claim 9, wherein the data are stored in the files by different business entities.

11. The method of claim 9, wherein the data are stored in the files in accordance with a format expected by a system that performs the financial reconciliation.

12. The method of claim 11, wherein different instances of the system that performs the financial reconciliation operate in conjunction with the files at the predetermined locations.

13. The method of claim 9, further comprising identifying one of the first and second files as not being timely received.

14. The method of claim 9, further comprising renaming the first and second files.

15. The method of claim 14, further comprising appending names of the first and second files with at least one of a date and a time stamp.

16. The method of claim 9, wherein the predetermined locations store files of business entities that are related to each other.

17. The method of claim 9, further comprising performing financial reconciliation between a third file and only one of the first and second files.

18. The method of claim 9, further comprising performing financial reconciliation between a third file and both of the first and second files.

19. The method of claim 9, further comprising performing financial reconciliation between the first and the second files.

20. The method of claim 9, wherein the step of displaying status information comprises simultaneously displaying names of the predetermine locations, and at least one of the first and second files.

21. The method of claim 20, wherein the step of displaying status information comprises indicating a state of a task by highlighting at least some displayed information with predetermined colors.

22. The method of claim 9, further comprising maintaining a status information web page for end users to view.

23. The method of claim 22, wherein the web page comprises a portion in which messages can be posted to inform end users of special information.

24. A method for electronic file handling, comprising:
receiving a plurality of electronic files at a central computer;
automatically checking for receipt of the electronic files against a list of electronic files expected to be received to ascertain whether files in the list of electronic files expected have been received;
storing individual files of the plurality of electronic files in a plurality of locations that will be accessed by multiple instances of an application;
accessing respective ones of the plurality of electronic files stored in the plurality of locations with the instances of the application and performing data matching with respect to at least one of the plurality of electronic files; and
providing status information with respect to receipt of the files and a status of the data matching.

25. The method of claim 24, wherein the electronic files represent collections of financial transactions.

26. The method of claim 24, wherein the data matching is part of financial reconciliation.

27. The method of claim 26, wherein the financial reconciliation is performed only with respect to data in one of the plurality of electronic files.

28. The method of claim 26, wherein the financial reconciliation is performed with respect to data in two of the plurality of electronic files.

29. The method of claim 26, wherein the financial reconciliation is performed with respect to data in at least two of the plurality of files and data in a separate file.

30. The method of claim 26, wherein a system for performing the financial reconciliation is resident on a server other than the central server.

31. The method of claim 24, wherein the multiple instances of the application are operating on different servers.

32. The method of claim 24, further comprising monitoring reports generated by the multiple instances of the application.

33. The method of claim 32, further comprising sweeping generated re ports to predetermined locations.

34. The method of claim 33, wherein the predetermined locations comprise locations on the central computer.
